(19) United States
(12) Patent Application Publication
(10) Pub. No.: US 2026/0016655 A1
(43) Pub. Date: Jan. 15, 2026

(54) LENS DEVICE AND IMAGING APPARATUS

(71) Applicant: CANON KABUSHIKI KAISHA, Tokyo (JP)

(72) Inventor: SHIGEHIRO TORII, Saitama (JP)

(21) Appl. No.: 19/261,834

(22) Filed: Jul. 7, 2025

(30) Foreign Application Priority Data
Jul. 12, 2024 (JP) 2024-112312

(51) Int. Cl. G02B 7/10; G02B 7/02; G03B 17/14

(52) U.S. Cl. CPC G02B 7/102; G02B 7/021; G03B 17/14

(57) ABSTRACT

A lens device includes a mount having a contact surface contacting an exterior member, a first optical system including a plurality of lenses, a lens holding barrel holding lenses, a first drive unit configured to move the lens holding barrel forward and backward along an optical axis of the first optical system, a light amount adjustment unit including a second drive unit configured to adjust an amount of light in the first optical system, and a regulation member including a regulation portion configured to regulate a position of the light amount adjustment unit along the optical axis. At least part of the lenses held by the lens holding barrel is disposed on an image plane side of the contact surface along the optical axis. The first drive unit, the second drive unit, and the regulation portion are disposed at different positions in a plane orthogonal to the optical axis.

### BACKGROUND

### Field of the Technology

The present disclosure relates to a lens device and an imaging apparatus.

### Description of the Related Art

Conventionally, various approaches have been proposed to achieve the miniaturization of lens devices. Japanese Patent Application Laid-Open No. 2023-181368 discusses a lens device in which a drive unit for moving a lens forward and backward along the optical axis is arranged at a position, along the optical axis, intersecting the surface of contact between the lens mount and the camera mount.

### SUMMARY

According to an aspect of the present disclosure, a lens device includes a mount having a contact surface that contacts an exterior member, a first optical system including a plurality of lenses, a lens holding barrel holding at least one of the plurality of lenses, a first drive unit configured to move the lens holding barrel forward and backward along an optical axis of the first optical system, a light amount adjustment unit including a second drive unit configured to adjust an amount of light in the first optical system, and a regulation member including a regulation portion configured to regulate a position of the light amount adjustment unit along the optical axis, wherein at least part of the at least one of the plurality of lenses held by the lens holding barrel is disposed on an image plane side relative to the contact surface along the optical axis, and wherein the first drive unit, the second drive unit, and the regulation portion are disposed at different positions in a plane orthogonal to the optical axis.

Features of the present disclosure will become apparent from the following description of embodiments with reference to the attached drawings. The following description of embodiments is described by way of example.

### BRIEF DESCRIPTION OF THE DRAWINGS

FIG. 1 is a perspective view of a lens device and an imaging device according to a first exemplary embodiment.

FIG. 2 is an exploded perspective view of a lens unit according to the first exemplary embodiment.

FIG. 3 is an exploded perspective view of the lens device according to the first exemplary embodiment.

FIG. 4 is a cross-sectional view of the lens unit according to the first exemplary embodiment.

FIG. 5 is a cross-sectional view of the lens device according to the first exemplary embodiment.

FIG. 6 is a cross-sectional view of the lens device according to the first exemplary embodiment.

FIG. 7 is an exploded perspective view of a lens unit according to a second exemplary embodiment.

FIG. 8 is an exploded perspective view of the lens device according to the second exemplary embodiment.

FIG. 9 is a cross-sectional view of the lens unit according to the second exemplary embodiment.

FIG. 10 is a cross-sectional view of the lens device according to the second exemplary embodiment.

FIG. 11 is a cross-sectional view of the lens device according to the second exemplary embodiment.

FIG. 12 is a cross-sectional view of the lens device according to the second exemplary embodiment.

### DESCRIPTION OF THE EMBODIMENTS

Hereinafter, exemplary embodiments of the present disclosure will be described in detail with reference to the accompanying drawings. In the drawings, the same members are denoted by the same reference numerals, and redundant descriptions thereof will be omitted. Each exemplary embodiment relates to a lens device including drive units.

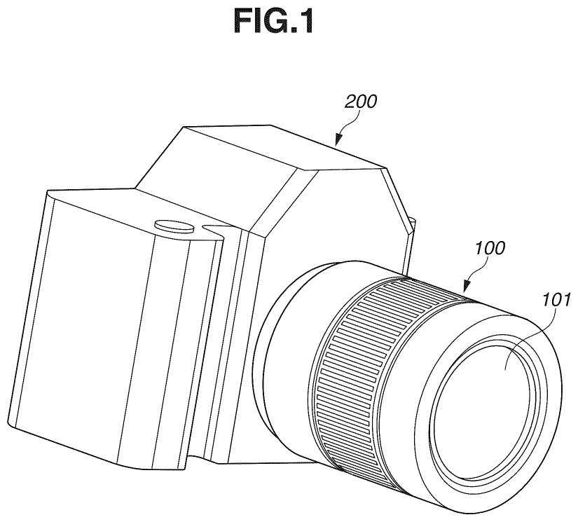

FIG. 1 is a schematic diagram illustrating an imaging system. As illustrated in FIG. 1, the imaging system includes a lens device 100 and a camera body 200. The camera body 200 includes an image sensor.

The image sensor receives light from the lens device 100. The lens device 100 includes a lens unit 101 that guides light from an object to the image sensor. The lens device 100 is mounted on the camera body 200. The lens device 100 may be attachable to and detachable from the camera body 200, and the lens device 100 is configured to be attachable to and detachable from the camera body 200 via a mount (not illustrated). The lens device 100 includes a contact portion that enables communication with a control unit (not illustrated), a lens drive instruction unit (not illustrated), and the camera body 200. The camera body 200 includes a contact portion that enables communication with a control unit (not illustrated), the image sensor (not illustrated), and the lens device 100. The lens device 100 may be integrated with the camera body 200.

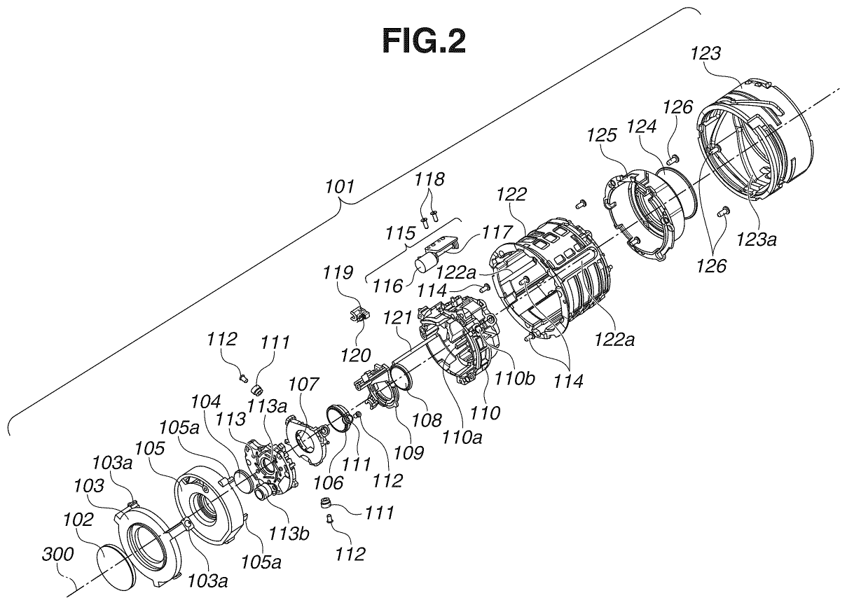

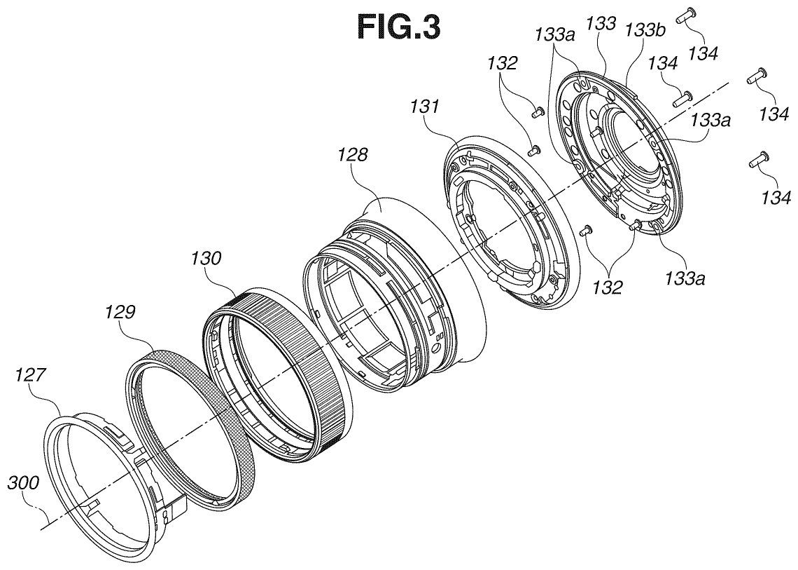

A first exemplary embodiment of the present disclosure will be described below. FIG. 2 is an exploded perspective view illustrating a configuration of the lens unit 101 according to the present exemplary embodiment. FIG. 3 is an exploded perspective view illustrating a configuration of the exterior configuration of the lens device 100 according to the present exemplary embodiment.

The lens unit 101 includes an optical system including a plurality of lenses. The lens unit 101 includes a first lens 102, a second lens 104, a third lens 106, and a fourth lens 108 arranged along the optical axis from the object side toward the image plane side. The lens unit 101 includes a first lens holding barrel 103 that holds the first lens 102, a second lens holding barrel 105 that holds the second lens 104, a third lens holding barrel 107 that holds the third lens 106, and a fourth lens holding barrel 109 that holds the fourth lens 108. The lens unit 101 further includes a base 110 (base member) that holds the first lens holding barrel 103, the second lens holding barrel 105, the third lens holding barrel 107, and the fourth lens holding barrel 109. The third lens holding barrel 107 is held in place on the base 110 with rollers 111 and screws 112.

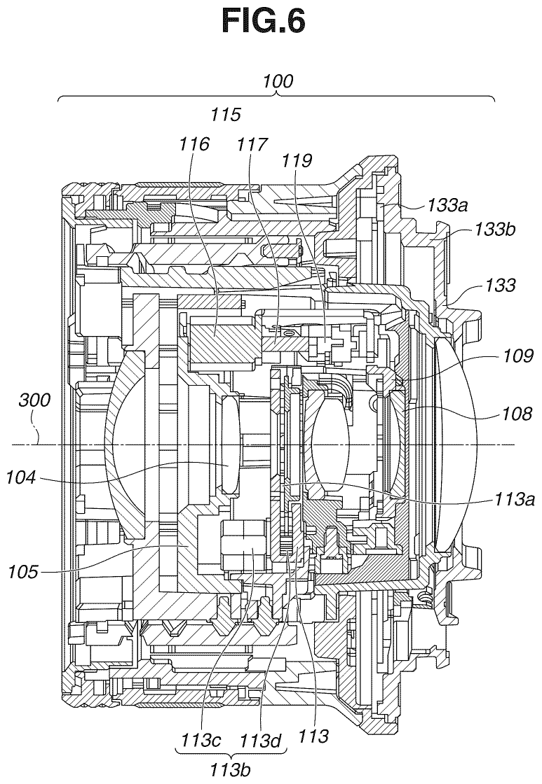

The lens unit 101 includes a light amount adjustment unit 113. The light amount adjustment unit 113 includes a light amount adjustment drive unit 113b (second drive unit) that enables adjustment of an amount of light by exposing or retracting an unillustrated aperture blade through an aperture 113a. The light amount adjustment drive unit 113b includes a light amount adjustment drive source 113c (illustrated in FIG. 6) and a gear portion (not illustrated), and the light amount adjustment drive unit 113b is electrically connected to a fixed substrate (not illustrated) via a flexible substrate (not illustrated). The position of the light amount adjustment unit 113 along an optical axis 300 is regulated by regulation portions 105a of the second lens holding barrel 105 (regulation member) and the base 110. The second lens holding barrel 105 is held in place on the base 110 with screws 114.

The lens unit 101 includes a first drive unit 115 that enables the fourth lens holding barrel 109 to move forward and backward along the optical axis 300. The first drive unit 115 includes a focus drive source 116 and a screw portion 117. The first drive unit 115 is secured to the base 110 with screws 118. The first drive unit 115 is electrically connected to the fixed substrate (not illustrated) via the flexible substrate (not illustrated). The fourth lens holding barrel 109 is provided with a rack 119, which is threadedly engaged with the screw portion 117, and a spring 120 for eliminating backlash. The fourth lens holding barrel 109 is held by a guide bar 121 (guide member) and a guide portion 110a of the base 110 such that the fourth lens holding barrel 109 is linearly guided without play. The guide bar 121 is clamped between the second lens holding barrel 105 and the base 110.

The first lens holding barrel 103 includes cam followers 103a. The base 110 includes follower portions 110b. The cam followers 103a of the first lens holding barrel 103 and the follower portions 110b of the base 110 are fitted into linear guide grooves 122a of a guide barrel 122 and cam grooves 123a of a cam ring 123, and the cam followers 103a of the first lens holding barrel 103 and the follower portions 110b of the base 110 are held to be movable forward and backward along the optical axis 300.

The lens unit 101 includes a fifth lens 124 and a fifth lens holding barrel 125 that holds the fifth lens 124. The fifth lens holding barrel 125 is secured to the guide barrel 122 with screws 126.

The lens device 100 includes a front ring 127 and an exterior member 128. The front ring 127 is held in place on the exterior member 128 by a bayonet coupling. The lens device 100 includes a focus ring 129, a zoom ring 130. The focus ring 129 and the zoom ring 130 are held in place by the front ring 127 and the exterior member 128 such that the focus ring 129 and the zoom ring 130 are rotatable within a fixed range. The rotation amount and the rotation direction of the focus ring 129 are detected through electrical connection to the fixed substrate (not illustrated) via the flexible substrate (detection unit, not illustrated). Based on the detection results, the first drive unit 115 is driven to move the fourth lens holding barrel 109 forward or backward along the optical axis 300, thus performing focus adjustment. The zoom ring 130 is coupled to the cam ring 123 via a key member (not illustrated), and the rotation thereof moves the first lens holding barrel 103 and the base 110 forward and backward along the optical axis 300. The rotation amount and the rotation direction of the zoom ring 130 are detected through electrical connection to the fixed substrate (not illustrated) via the flexible substrate (detection unit, not illustrated).

The lens device 100 includes a fixed barrel 131 and a mount 133. The fixed barrel 131 is held in place on the exterior member 128 with screws 132. The mount 133 has contact surfaces 133a that contact contact surfaces 131a (not illustrated) of the fixed barrel 131, and the mount 133 is fixed to the fixed barrel 131 with screws 134. The mount 133 includes a bayonet portion 133b that is bayonet-coupled to a mount (camera mount) on the camera body 200. The lens device 100 is detachably held in place on the camera body 200 via the bayonet portion 133b. The mount 133 holds a contact portion (not illustrated) that is electrically connected to the fixed substrate (not illustrated), and the mount 133 is electrically connected to a contact portion held by the camera mount.

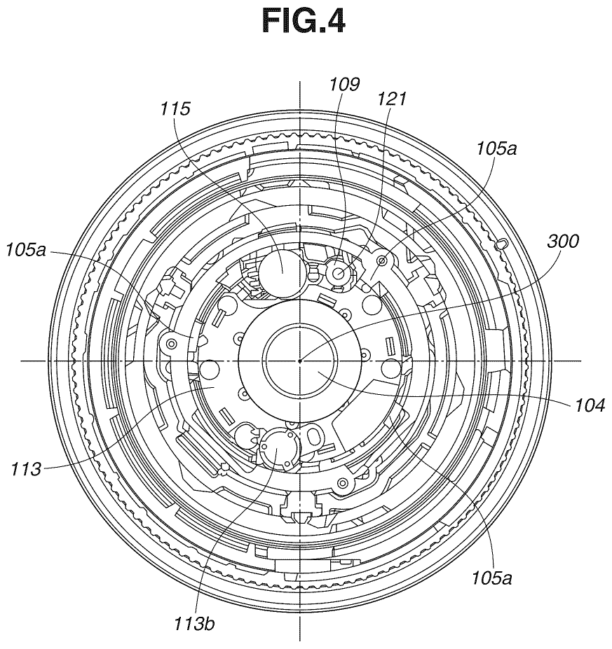

FIG. 4 is a diagram illustrating a cross-sectional view of the lens device 100 according to the first exemplary embodiment of the present disclosure, taken along a plane orthogonal to the optical axis 300. As illustrated in FIG. 4, in the plane (cross-section) orthogonal to the optical axis 300 of the lens device 100, the regulation portions 105a, the light amount adjustment drive unit 113b, the first drive unit 115, and the guide bar 121 are arranged in phases that do not overlap (positions that do not overlap) one another.

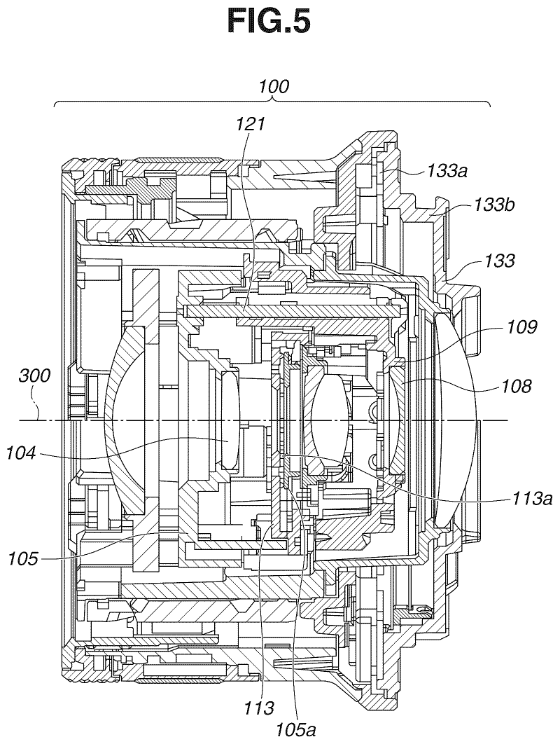

FIGS. 5 and 6 are diagrams each illustrating a cross-sectional view including the optical axis 300 of the lens device 100 according to the first exemplary embodiment of the present disclosure. The fourth lens 108 held by the fourth lens holding barrel 109 is disposed on the image plane side of the contact surfaces 133a of the mount 133 along the optical axis 300. The focus drive source 116 of the first drive unit 115 and the light amount adjustment drive unit 113b of the light amount adjustment unit 113 are disposed on the object side of both the fourth lens 108 and the contact surfaces 133a along the optical axis 300.

Disposition of a drive unit for a focus lens within the inner diameter of a mount can lead to an increase in the outer diameter of a lens device. Furthermore, if the drive unit for the focus lens and a drive unit for a diaphragm are disposed in the same phase (i.e., overlapping positions along the optical axis), the overall length of the lens device may need to be increased. In the lens device 100 according to the present exemplary embodiment, the focus drive source 116 and the light amount adjustment drive unit 113b are disposed in different phases in a plane orthogonal to the optical axis, and the fourth lens 108 (focus lens) is disposed on the image plane side of the first drive unit 115 (at least partially overlapping with the inner diameter of the mount). This arrangement can achieve miniaturization of the lens device.

In other words, along the optical axis 300, the fourth lens 108 to be driven by the first drive unit 115 is disposed within the inner diameter of the mount 133, and the light amount adjustment drive unit 113b and the first drive unit 115 are disposed on the object side of the contact surfaces 133a, where there is more available space. In a plane orthogonal to the optical axis 300, the regulation portions 105a that restrict the position of the light amount adjustment unit 113 along the optical axis 300, the light amount adjustment drive unit 113b, the first drive unit 115, and the guide bar 121 are disposed in phases that do not overlap (at positions that do not overlap) one another. This configuration enables a reduction in the outer diameter of the lens device even with a short flange back large-aperture lens, thus achieving miniaturization.

Additionally, the focus drive source 116 and the light amount adjustment drive source 113c are disposed on the object side of the aperture 113a of the light amount adjustment unit 113 along the optical axis 300. The first drive unit 115 and the light amount adjustment drive unit 113b are disposed to overlap the regulation portions 105a of the second lens holding barrel 105 and the second lens 104 along the optical axis 300. In other words, the regulation portions 105a and the second lens 104 are disposed in a plane orthogonal to the optical axis 300.

Further, the first drive unit 115 and the light amount adjustment drive unit 113b are disposed to overlap the guide bar 121 along the optical axis 300, so that the overall length of the lens device 100 can be shortened, thus achieving miniaturization. In other words, the first drive unit 115, the light amount adjustment drive source 113c, and the guide bar 121 are disposed in a plane orthogonal to the optical axis 300. The disposition of the focus drive source 116 and the light amount adjustment drive unit 113b on the object side of the aperture 113a of the light amount adjustment unit 113 along the optical axis 300 enables the realization of a miniaturized lens device with a configuration capable of reducing the influence of magnetic noise.

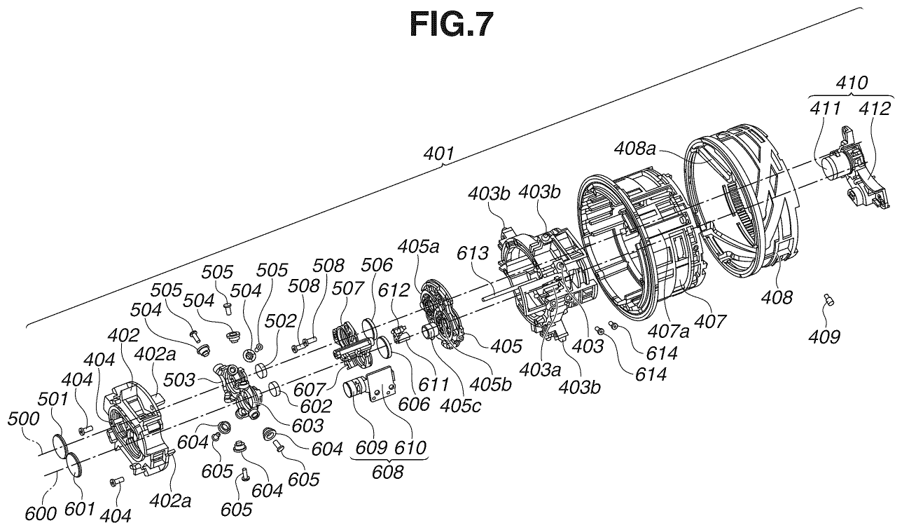

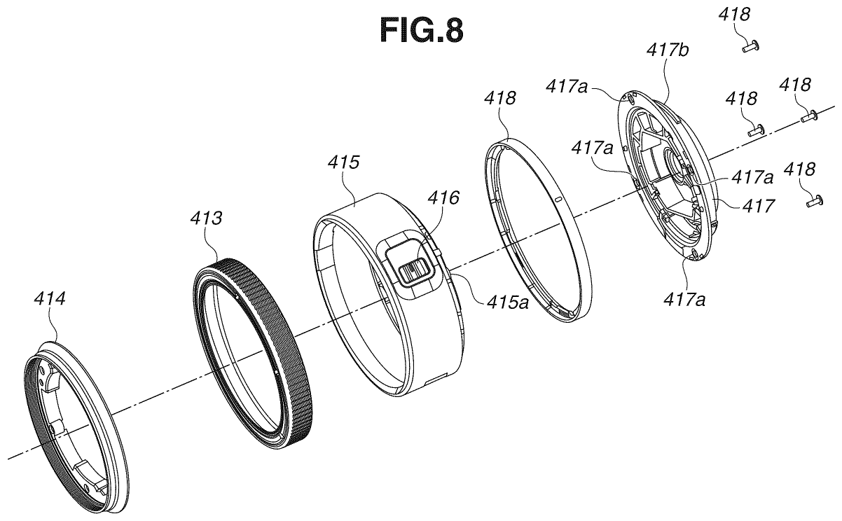

A second exemplary embodiment of the present disclosure will now be described. FIG. 7 is an exploded perspective view illustrating a configuration of a lens unit 401 according to the present exemplary embodiment. FIG. 8 is an exploded perspective views illustrating a configuration of the exterior configuration of a lens device 400 according to the present exemplary embodiment.

The lens unit 401 includes a first optical system disposed along a first optical axis 500 and a second optical system disposed along a second optical axis 600. In the present exemplary embodiment, the first and second optical systems are disposed in parallel, and both the first and second optical systems are coaxial optical systems. The first optical system includes a first lens 501, a second lens 502, and a third lens 506 from the object side toward the image plane side along the first optical axis 500. The second optical system includes a first lens 601, a second lens 602, and a third lens 606 from the object side toward the image plane side along the second optical axis 600.

The lens unit 401 includes a first lens holding barrel 402 that holds the first lens 501 and the first lens 601, a second lens holding barrel 503 that holds the second lens 502, and a second lens holding barrel 603 that holds the second lens 602. The second lens holding barrel 503 is fixed to the first lens holding barrel 402 with rollers 504 and screws 505, and the position of the second lens holding barrel 503 is defined. The rollers 504 in the present exemplary embodiment are eccentric rollers with which the position of the second lens holding barrel 503 is adjustable. Similarly, the second lens holding barrel 603 is fixed to the first lens holding barrel 402 with rollers 604 and screws 605, and the position of the second lens holding barrel 603 is defined. The rollers 604 in the present exemplary embodiment are eccentric rollers with which the position of the second lens holding barrel 603 is adjustable. The first lens holding barrel 402 is fixed to a base 403 (base member) with screws 404, and the position of the first lens holding barrel is defined.

The lens unit 401 further includes a third lens holding barrel 507 that holds the third lens 506 and a third lens holding barrel 607 that holds the third lens 606. The third lens holding barrel 507 is fixed to the base 403 with screws 508, and the position of the third lens holding barrel 507 is defined. The third lens holding barrel 607 has a function as an adjustment unit for adjusting the focus difference between the first and second optical systems.

The lens unit 401 further includes a focus difference adjustment drive unit 608. The focus difference adjustment drive unit 608 includes a focus difference adjustment drive source 609 (first drive unit) and a screw portion 610. The third lens holding barrel 607 is provided with a rack 611, which is threadedly engaged with the screw portion 610 of the focus difference adjustment drive unit 608, and a spring 612 for eliminating backlash. The third lens holding barrel 607 is configured to be movable forward and backward along the second optical axis 600 without play with respect to a guide bar 613 (guide member) a guide portion 403a of the base 403. The guide bar 613 is clamped between the first lens holding barrel 402 and the base 403.

The focus difference adjustment drive unit 608 is electrically connected to a fixed substrate (not illustrated) by a flexible substrate (not illustrated). The focus difference adjustment drive unit 608 is fixed to the base 403 with screws 614. In the present exemplary embodiment, the focus difference adjustment drive unit 608 drives only the third lens holding barrel 607 to adjust the focus difference between the first and second optical systems. Thus, the focus difference adjustment drive unit 608 has a light drive load, so that the drive actuator (focus difference adjustment drive source 609) can be miniaturized, allowing miniaturization of the lens device. Additionally, the third lens holding barrel 507 is a fixed unit, so that the present exemplary embodiment achieves higher focus difference adjustment accuracy as compared with a configuration with the third lens holding barrel 507 set as a focus adjustment unit.

The lens unit 401 further includes a light amount adjustment unit 405. The light amount adjustment unit 405 includes a light amount adjustment drive unit 405c (second drive unit) that enables adjustment of the amount of light by exposing or retracting unillustrated aperture blades through an aperture 405a corresponding to the first optical system and an aperture 405b corresponding to the second optical system. The light amount adjustment drive unit 405c includes a light amount adjustment drive source 405d and a gear portion 405c (not illustrated), and the light amount adjustment drive unit 405c is electrically connected to the fixed substrate (not illustrated) by the flexible substrate (not illustrated). The position of the light amount adjustment unit 405 along the first optical axis 500 (second optical axis 600) is regulated by regulation portions 402a of the first lens holding barrel 402 (regulation member) and the base 403.

The base 403 includes cam followers 403b. The cam followers 403b of the base 403 are inserted into linear guide grooves 407a of a guide barrel 407 and cam grooves 408a of a cam ring 408. The base 403 is held to be movable forward and backward along the first optical axis 500 (second optical axis 600). This movement is driven by rotation of the cam ring 408. The rotation range of the cam ring 408 is regulated by a screw 409.

The lens unit 401 further includes a focus drive unit 410 (third drive unit). The focus drive unit 410 includes a focus drive source 411 and a gear portion 412, and the focus drive unit 410 is fixed to the guide barrel 407 with a screw (not illustrated). The focus drive unit 410 is electrically connected to the fixed substrate (not illustrated) via the flexible substrate (not illustrated). In the focus drive unit 410, the rotation of the focus drive source 411 rotates the cam ring 408 via the gear portion 412 to move the base 403 forward and backward along the first optical axis 500 (the second optical axis 600).

The lens device 400 according to the present exemplary embodiment includes a focus ring 413, a front ring 414, an exterior member 415, and a mount 417. The focus ring 413 is clamped between the front ring 414 and the exterior member 415 such that focus ring 413 is rotatable within a fixed range. The exterior member 415 is fixed to the guide barrel 407 with a screw (not illustrated). The rotation amount and rotation direction of the focus ring 413 are detected through electrical connection to the fixed substrate (not illustrated) via the flexible substrate (detection unit, not illustrated). Based on the detection results, the focus drive unit 410 is driven to move the base 403 forward or backward along the first optical axis 500, thus performing focus adjustment. A slide switch 416, which is held by the exterior member 415, can be toggled to switch a switch that is electrically connected to the fixed substrate (not illustrated) via the flexible substrate (not illustrated) which is connected to the slide switch 416. When the switch is toggled, the mode changes from a focus adjustment mode to a focus difference adjustment drive mode, in which the focus difference adjustment drive unit 608 drives only the third lens holding barrel 607.

The mount 417 has contact surfaces 417a that contact contact surfaces 415a of the exterior member 415, and the mount 417 is fixed to the exterior member 415 with screws 418. The mount 417 includes a bayonet portion 417b that is bayonet-coupled to a mount (camera mount) on the camera body 200. The lens device 400 is detachably held in place on the camera body 200 with the bayonet portion 417b. The mount 417 holds a contact portion (not illustrated) which is electrically connected to the fixed substrate (not illustrated), and the mount 417 is electrically connected to a contact portion held by the camera mount.

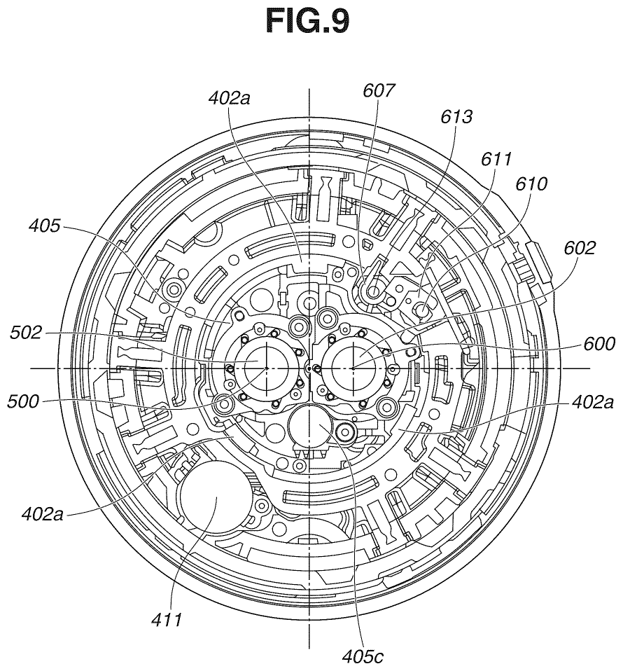

FIG. 9 is a diagram illustrating a cross-sectional view of the lens device 400 according to the second exemplary embodiment of the present disclosure, taken along a plane orthogonal to the first optical axis 500 and the second optical axis 600. As illustrated in FIG. 9, in the plane orthogonal to the first optical axis 500 (the second optical axis 600) of the lens device 400, the regulation portions 402a, the light amount adjustment drive unit 405c, the focus difference adjustment drive unit 608 (screw portion 610), and the guide bar 613 are disposed at different positions.

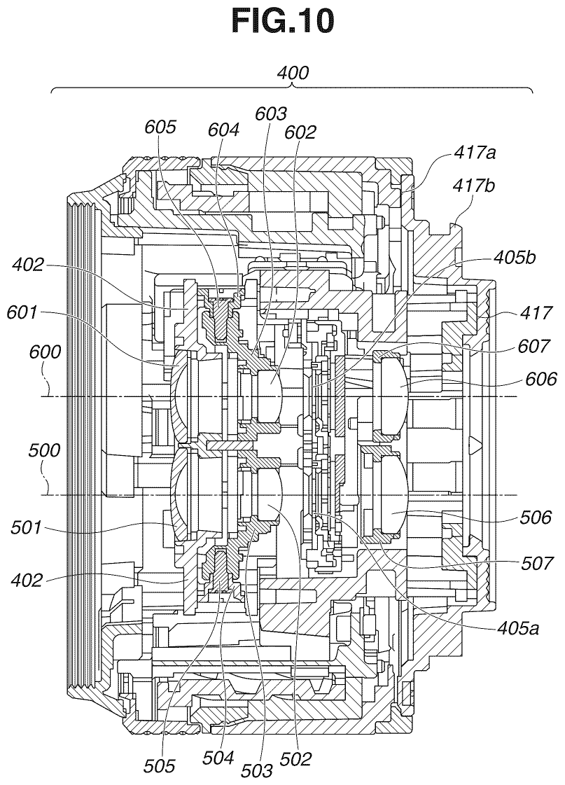

FIGS. 10, 11 and 12 are each a cross-sectional view of the lens device 400 according to the second exemplary embodiment of the present disclosure, taken along a plane parallel to the first and second optical axes 500 and 600. FIGS. 10, 11 and 12 each illustrate a cross-sectional view of the lens device 400 at different phases.

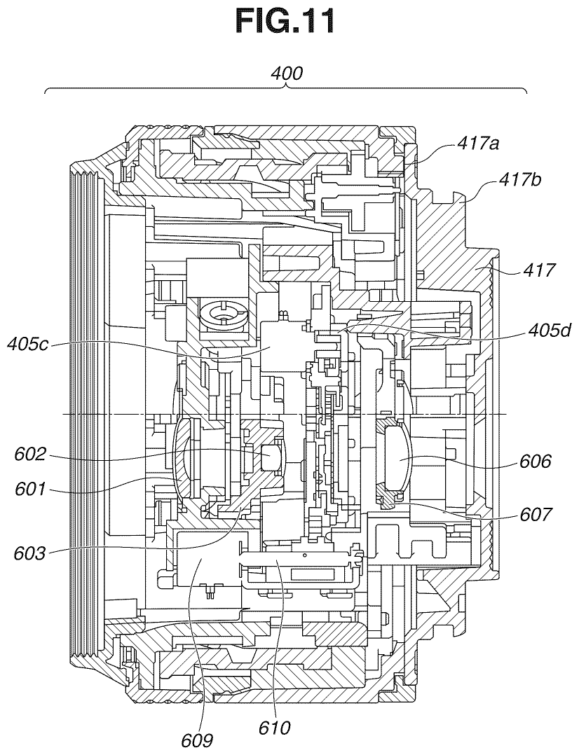

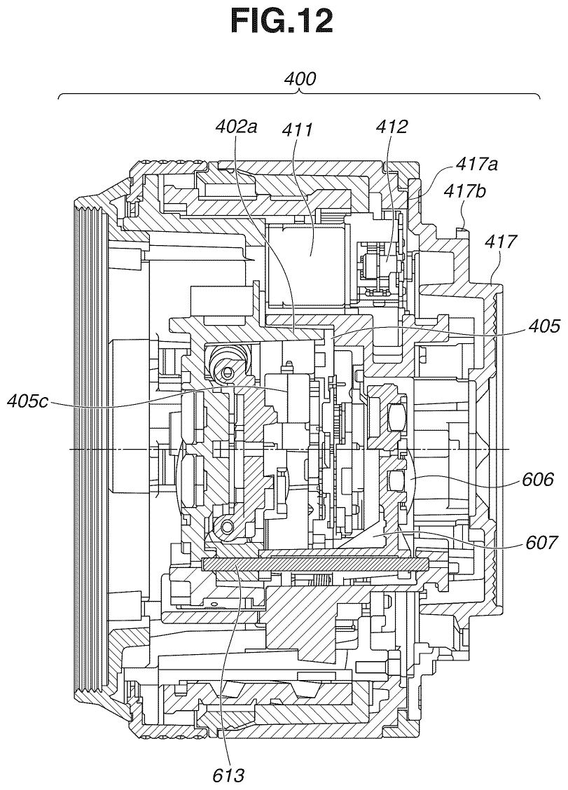

FIG. 10 is a diagram illustrating a plane including the first and second optical axes 500 and 600. FIG. 11 is a diagram illustrating, in an upper part thereof, a plane including the light amount adjustment drive unit 405c, and, in a lower part thereof, a focus difference adjustment drive unit 608 (focus difference adjustment drive source 609, screw portion 610). FIG. 12 is a diagram illustrating, in an upper part thereof, a plane including the focus drive source 411, and, in a lower part thereof, the guide bar 613. The third lens 606 held by the third lens holding barrel 607 is disposed on the image plane side of the contact surfaces 417a of the mount 417 along the second optical axis 600 (the first optical axis 500). The focus difference adjustment drive source 609 of the focus difference adjustment drive unit 608 and the light amount adjustment drive source 405d of the light amount adjustment unit 405 are disposed on the object side of the contact surfaces 417a along the first and second optical axes 500 and 600.

In other words, along the first and second optical axes 500 and 600, at least part of the third lens 606 to be driven by the focus difference adjustment drive unit 608 is disposed within the inner diameter of the mount 417 on the image plane side of the contact surfaces 417a. The light amount adjustment drive unit 405c (light amount adjustment drive source 405d, gear portion 405e) and the focus difference adjustment drive unit 608 (focus difference adjustment drive source 609, screw portion 610) are disposed on the object side of the contact surfaces 417a, where there is more available space.

This configuration can reduce the outer diameter of the lens device even with a short flange back dual-lens system, thus achieving miniaturization.

In addition, the focus drive source 411, the light amount adjustment drive unit 405c, and the focus difference adjustment drive source 609 are disposed on the object side of the apertures 405a and 405b of the light amount adjustment unit 405 along the first optical axis 500 (the second optical axis 600). Additionally, the light amount adjustment drive unit 405c and the focus difference adjustment drive unit 608 (focus difference adjustment drive source 609, screw portion 610) are disposed to overlap the regulation portions 402a, the second lens 502, and the second lens 602 along the first optical axis 500 (second optical axis 600). Specifically, the regulation portions 402a, the second lens 502, and the second lens 602 are disposed in a plane orthogonal to the first optical axis 500 (the second optical axis 600).

Additionally, the light amount adjustment drive unit 405c and the focus difference adjustment drive unit 608 are disposed to overlap the guide bar 613 along the first and second optical axes 500 and 600, thus enabling a reduction in the overall length of the lens device 400 and achieving miniaturization. In other words, the light amount adjustment drive unit 405c, the focus difference adjustment drive unit 608, and the guide bar 613 are arranged in a plane orthogonal to the first optical axis 500 (second optical axis 600). The light amount adjustment drive source 405d and the focus difference adjustment drive source 609 are disposed on the object side of the apertures 405a and 405b of the light amount adjustment unit 405 along the first and second axes 500 and 600. The disposition of the components in such a manner enables the realization of a compact lens device with a configuration capable of reducing the influence of magnetic noise. Additionally, the disposition of the focus drive source 411 on the object side of the apertures 405a and 405b of the light amount adjustment unit 405 along the first and second optical axes 500 and 600 enables the realization of a configuration capable of reducing the influence of magnetic noise.

The present disclosure is applicable to lens devices, particularly to those having features such as rear focus, floating focus, and dual-lens optical systems.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-112312, filed Jul. 12, 2024, which is hereby incorporated by reference herein in its entirety.

What is claimed is:

1. A lens device, comprising:
a mount having a contact surface that contacts an exterior member;
a first optical system including a plurality of lenses;
a lens holding barrel holding at least one of the plurality of lenses;
a first drive unit configured to move the lens holding barrel forward and backward along an optical axis of the first optical system;
a light amount adjustment unit including a second drive unit configured to adjust an amount of light in the first optical system; and
a regulation member including a regulation portion configured to regulate a position of the light amount adjustment unit along the optical axis,
wherein at least part of the at least one of the plurality of lenses held by the lens holding barrel is disposed on an image plane side relative to the contact surface along the optical axis, and
wherein the first drive unit, the second drive unit, and the regulation portion are disposed at different positions in a plane orthogonal to the optical axis.

2. The lens device according to claim 1, wherein the first drive unit includes a first drive source and a screw portion, and
wherein the second drive unit includes a second drive source and a gear portion.

3. The lens device according to claim 2, wherein the first drive source and the second drive source are disposed on an object side relative to the contact surface and an aperture of the light amount adjustment unit along the optical axis.

4. The lens device according to claim 1, further comprising:
a base member holding the lens holding barrel; and
a guide member configured to guide forward and backward movement of the lens holding barrel along the optical axis,
wherein the base member and the regulation portion hold the guide member.

5. The lens device according to claim 4, wherein the guide member, the first drive unit, the second drive unit, and the regulation portion are disposed at different positions in a plane orthogonal to the optical axis.

6. The lens device according to claim 1,
wherein the regulation member holds a lens different from the at least one of the plurality of lenses held by the lens holding barrel, and
wherein the lens held by the regulation member, the first drive unit, and the second drive unit are disposed at different positions in a plane orthogonal to the optical axis.

7. The lens device according to claim 1, wherein the first drive unit is configured to perform driving for focus adjustment.

8. The lens device according to claim 1, further comprising a second optical system including a plurality of lenses and disposed in parallel with the first optical system,
wherein the first drive unit is configured to move the lens holding barrel forward and backward along the optical axis to adjust a focus difference between the first optical system and the second optical system.

9. The lens device according to claim 8, wherein both the first optical system and the second optical system are coaxial optical systems.

10. The lens device according to claim 8,
wherein the regulation member holds a lens different from the at least one of the plurality of lenses held by the lens holding barrel, and
wherein the lens held by the regulation member, the first drive unit, and the second drive unit are disposed at positions overlapping with one another along the optical axis.

11. The lens device according to claim 8, further comprising:
a base member holding the lens holding barrel; and
a third drive unit configured to move the base member forward and backward along the optical axis.

12. The lens device according to claim 11, wherein the third drive unit is configured to perform driving for focus adjustment.

13. The lens device according to claim 11. wherein the third drive unit is disposed on an object side relative to the contact surface along the optical axis.

14. An imaging apparatus comprising:
the lens device according to claim 1; and
a camera body including an image sensor configured to receive light from the lens device.
